(19) United States
(12) Patent Application Publication
(10) Pub. No.: US 2014/0297809 A1
(43) Pub. Date: Oct. 2, 2014

(54) APPARATUS AND METHOD FOR PROCESSING MULTIPLE OPEN APIS

(71) Applicant: Samsung Electronics Co., Ltd., Suwon-si (KR)

(72) Inventor: Geunyong KIM, Suwon-si (KR)

(73) Assignee: Samsung Electronics Co., Ltd., Suwon-si (KR)

(21) Appl. No.: 14/200,947

(22) Filed: Mar. 7, 2014

(30) Foreign Application Priority Data
Mar. 27, 2013 (KR) 10-2013-0032943

(51) Int. Cl. G06F 9/54; G06F 17/30

(52) U.S. Cl. CPC G06F 9/541; G06F 17/30964
USPC 709/219

(57) ABSTRACT

A method of processing multiple Application Programmer Interfaces (APIs) by an API server is provided. The method includes receiving a request message of a first API from a terminal, the request message including information on one or more second APIs associated with the first API, identifying the one or more second APIs by analyzing the information, searching for result data of the first API and the one or more second APIs in a database, storing the result data of the one or more second APIs, and transmitting a response message including the result data of the first API to the terminal.

### CROSS-REFERENCE TO RELATED APPLICATION(S)

This application claims the benefit under 35 U.S.C. §119(a) of Korean patent application filed on Mar. 27, 2013 and assigned Serial number 10-2013-0032943, the entire disclosure of which is hereby incorporated by reference.

### TECHNICAL FIELD

The present disclosure relates to an apparatus and a method for processing an open Application Programming Interface (API). More particularly, the present disclosure relates to an apparatus and a method for multi-processing open APIs of an independent function unit based on an open API platform.

### BACKGROUND

A method of providing a web service-based open Application Programming Interface (API) of the related art implements and provides API functions published in an open API server as independent functions. With the method of the related art, a client makes a request for a required API function interface according to the interworking standard and receives a result (return) value of the corresponding API function in the form of eXtensible Markup Language (XML).

However, when considering a search API, the API processing method of the related art has a relatively long response time. For example, a DataBase (DB) selective search API is dependent on a DB query time, and accordingly, the usability is reduced. Further, the API of the related art may have an order of an API request (for example, gift card registration→list search→detail search) according to a service flow. In this case, the API is sequentially processed according to the request order, and thus a processing time becomes longer. In addition, an open API platform of the related art provides only a response to a 1:1 request (for example, APIs perform independent functions and implement independent interfaces, respectively). Accordingly, there is a need for an improved apparatus and method for multi-processing open APIs of an independent function through only a one time call.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a method for multi-processing open Application Programming Interfaces (APIs) of an independent function through only a one time call. To this end, a client according to an embodiment of the present disclosure transmits an open API including a Hypertext Transfer Protocol (HTTP) header which can call a plurality of related APIs to an open API server and makes a request for processing multiple open APIs. Further, the open API server checks an API function (N) interface implemented in the unit of actual independent functions and header information and stores the checked API function (N) interface and header information in a temporary storage, and transmits a stored result value of the API when the corresponding open API is requested to be transmitted.

In accordance with an aspect of the present disclosure, a method of processing multiple APIs by an API server is provided. The method includes receiving a request message of a first API from a terminal, the request message including information on one or more second APIs associated with the first API, identifying the one or more second APIs by analyzing the information, searching for result data of the first API and the one or more second APIs in a database, storing the result data of the one or more second APIs, and transmitting a response message including the result data of the first API to the terminal.

In accordance with another aspect of the present disclosure, a method of processing multiple APIs by a terminal apparatus is provided. The method includes transmitting a request message of a first API to an API server, the request message including information on one or more second APIs associated with the first API, and receiving a response message including result data of the first API from the API server, wherein the API server processes and stores result data of the second APIs after transmitting the response message of the first API.

In accordance with another aspect of the present disclosure, an API server apparatus processing multiple APIs is provided. The API server apparatus includes an API virtual layer configured to receive a request message of a first API including information on one or more second APIs associated with the first API transmitted from a terminal, to analyze the information to identify the one or more second APIs, to search for and process result data of the first API and the one or more second APIs in a database, and to transmit a response message including the result data of the first API to the terminal, API functions configured to search for result data of a start API and a connection API in the database and to generate the result data under a control of the API virtual layer, and a storage configured to store the result data of the connection API under a control of the API virtual layer.

As described above, the present disclosure provides a method of multi-processing open APIs of independent functions through only a one time call, and particularly pre-processes an open API having a relatively long response time to have return data in advance and returns a result value without querying a DB when there is a real request, thereby providing the same effect as that of a cache. While the cache has a slow response time since it makes a real query in a first query, the present disclosure provides a quick response time even in a first query of a real request through parallel pre-processing.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a client and a server according to an embodiment of the present disclosure;

FIG. 2 is a flowchart illustrating an Application Programming Interface (API) processing procedure of a client in an API processing system, such as the client 110 in the API processing system having the structure as shown in FIG. 1, according to an embodiment of the present disclosure;

FIG. 3 is a flowchart illustrating an API processing procedure of a server in an API processing system, such as the server 120 in the API processing system having the structure as shown in FIG. 1, according to an embodiment of the present disclosure;

FIG. 4 is a flowchart illustrating a procedure of processing a start API of multiple APIs between a client and an API server according to an embodiment of the present disclosure;

FIG. 5 is a flowchart illustrating a procedure of processing a connection API of multiple APIs between a client and an API server according to an embodiment of the present disclosure;

FIG. 6 illustrates an example of processing a gift card registration and list search procedure through multiple APIs according to an embodiment of the present disclosure; and

FIG. 7 illustrates a procedure for automatically issuing a gift card of a terminal promotion through multiple APIs according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In general, an Application Programming Interface (API) has a language or a message type used when an application program communicates with a system program such as an operating system or a database management system. An API is implemented by calling a function providing a connection to a particular subroutine for an execution within a program. Accordingly, one API has several program modules or routines which already exist or should be connected to execute an operation requested by the call of the function. An open API refers to a published API that allows an Internet user to receive a web search result and a User Interface (UI) and also to directly develop an application program and a service.

In the following description, the term “open API” denotes an open application developing interface and the term “open API platform” denotes a service developing common core platform. The following description will be made based on an open API web service of a Representational State Transfer (REST) scheme between Simple Object Access Protocol (SOAP) and REST schemes as a representative communication scheme using a Hypertext Transfer Protocol (HTTP) protocol of the open API which has appeared by a Web 2.0 paradigm. The SOAP uses a SOAP message request and return technique and the REST uses a Uniform Resource Locator (URL) request, Extensible Markup Language (XML) return, and over HTTP technique.

In a case where a client makes a request for multiple open APIs including start and connection APIs in processing the APIs, if the client inserts header information of the connection API into the start API and makes a request for the start API, a server analyzes the header information according to the request for the start API, calls the start and connection APIs, stores result values thereof, and transmits a transaction identifier of the connection API to the client together with the result value of the start API. Thereafter, when the client calls the connection API, the client also calls a corresponding transaction identifier, and the API server accesses the stored result value of the connection API corresponding to the transaction identifier to respond to the client. Accordingly, when the client makes a request for the start API, the API server calls in advance and stores result values of the connection APIs. As a result, the API server can immediately transmit the stored result value when the client makes a request for the connection API (real request) and thus guarantee a quick response time of the API.

In the following description, the term “first API” is used as having the same meaning as that of the start API and the term “second API” is used as having the same meaning as that of the connection API. Further, information on the second API included in a first API request message may be a header format.

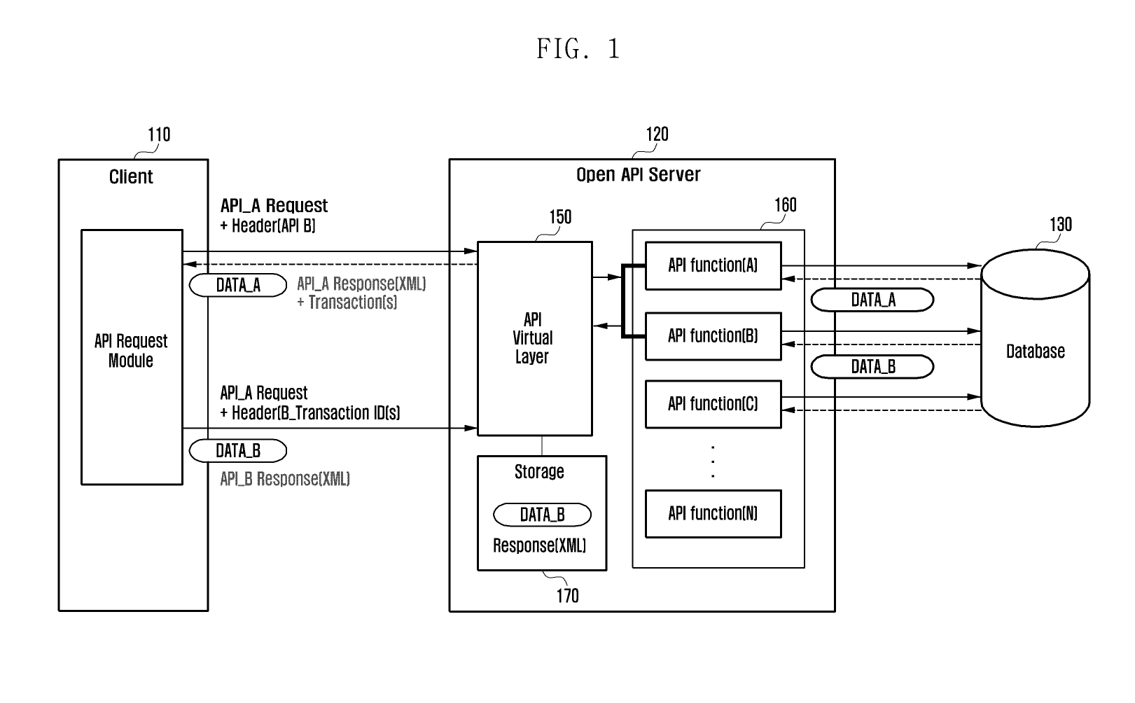

FIG. 1 is a block diagram illustrating a client and a server according to an embodiment of the present disclosure.

Referring to FIG. 1, a client 110 is a device making a request for an open API and includes an API request module. When the requested API corresponds to multiple open APIs, the client 110 also makes a request for header information of the multiple open APIs (hereinafter referred to as the connection API or the second API) connected when the first API (i.e., start API) is requested.

The client 110 may be a terminal device and include a communication unit, a storage unit, a controller, and the like. The controller may include the API request module. The communication unit transmits/receives an API request and response message to/from an API server 120. That is, the communication unit transmits the first API request message including information on one or more second APIs connected to the first API generated by the controller to the API server, receives a response message transmitted from the API server, and outputs the response message to the controller. The storage unit stores the first API response message under control of the controller. The controller generates the request message making a request for the first API and outputs the request message to the communication unit. When the communication unit receives a response message including first API result data, the communication unit stores identification information of the second API included in the response message in the storage unit.

The controller inserts information on the second API into the first API request message, and the information on the second API may include a parameter indicating whether multi-processing is performed, a parameter indicating a multi-processing scheme, a name of a connection parameter, a user of a connection parameter, a device name, and the like. At this time, the API server 120 generates a first API response message including identification information (e.g., a transaction ID) corresponding to each of the second APIs and transmits the generated first API response message to the client 110.

The client 110 generates a second API request message including identification information (e.g., transaction ID) of the corresponding second API from the storage unit and outputs the generated second API request message to the communication unit. The communication unit transmits the second API request message to the API server 120.

The API server 120 may include an API function (N) interface 160 implemented in the unit of actual independent functions, an API virtual Layer 150 for checking header information and storing the header information in a temporary storage, and a temporary storage (or memory) 170. When the client 110 makes a request for multiple open APIs, the API server 120 identifies header information of the connection open APIs, calls result values of the start open API and the connection open APIs, and stores the result values of the connection open APIs. When the result value of the start open API is responded, the API server 120 also transmits transaction IDs of the connection open APIs. Further, when the request for the connection open API is made, a transaction ID is identified without the call of a database 130 and a stored result value of the corresponding API is transmitted to the client.

The database 130 is a storage that stores actual API data.

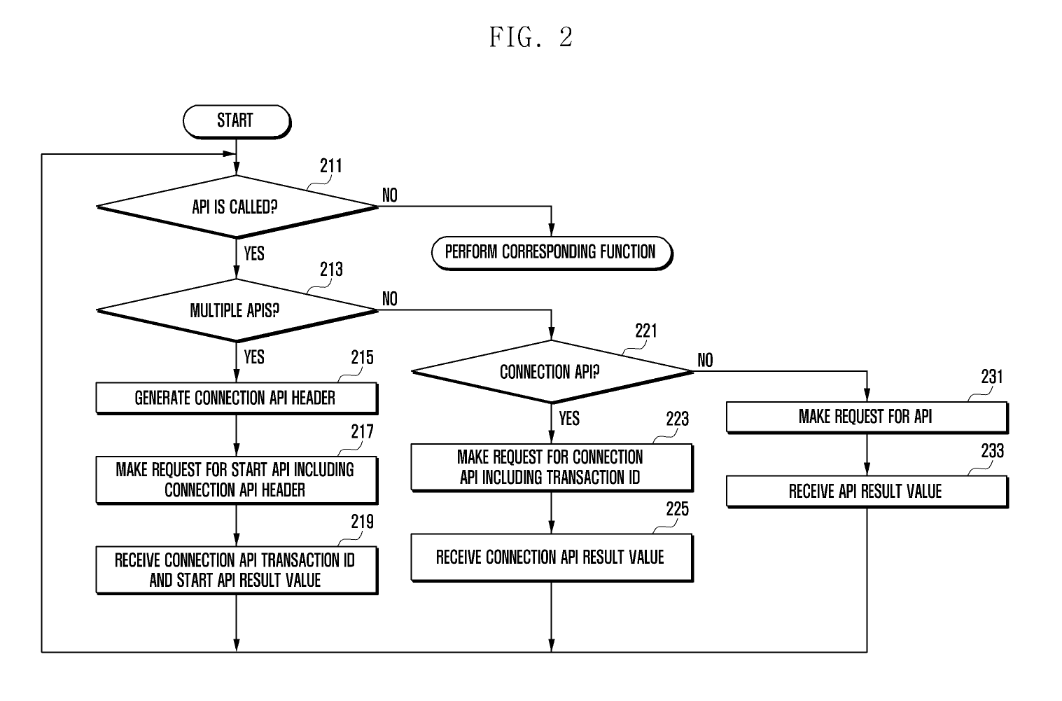

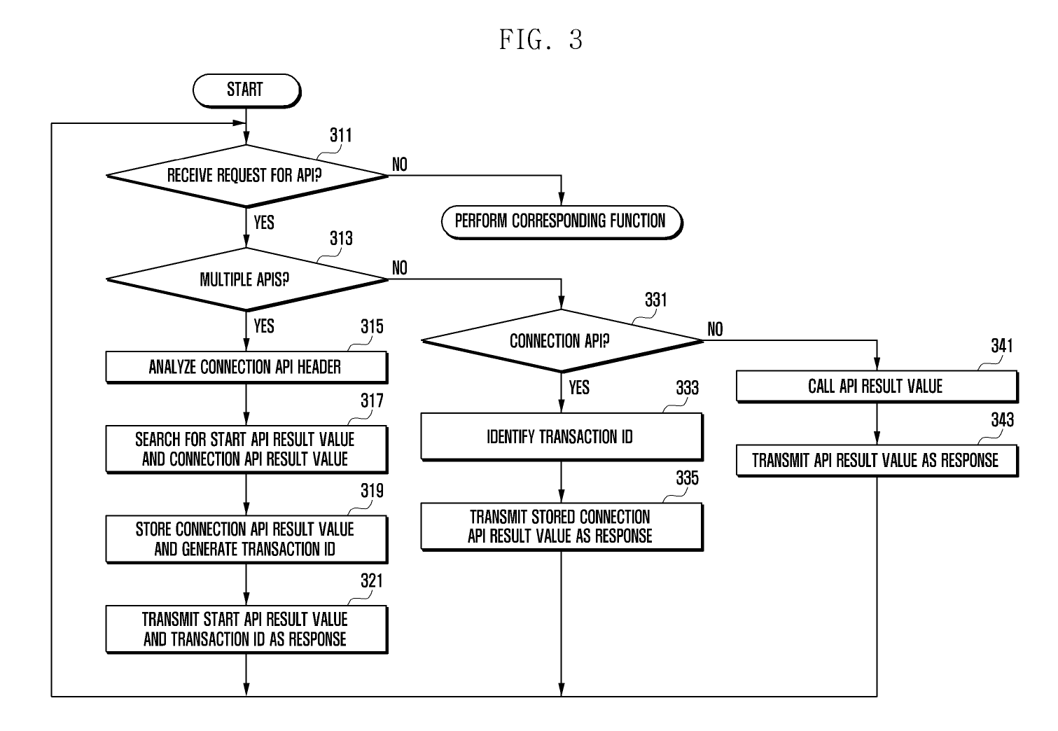

FIG. 2 is a flowchart illustrating an API processing procedure of a client in an API processing system, such as the client 110 in the API processing system having the structure as shown in FIG. 1, according to an embodiment of the present disclosure, and FIG. 3 is a flowchart illustrating an API processing procedure of a server in an API processing system, such as the server 120 in the API processing system having the structure as shown in FIG. 1, according to an embodiment of the present disclosure.

Referring to FIG. 2, when the API is called, the client 110 detects the call in operation 211 and identifies whether the called API corresponds to multiple APIs in operation 213. When the called API corresponds to multiple APIs, the client 110 detects it in operation 213 and generates a header of the connection API in operation 215. In FIG. 1, it is assumed that the multiple open APIs include an API_A and an API_B, the API_A is the start API, and the API_B is the connection API. In this case, the client 110 generates the header of the connection API in operation 215, and a structure of the header of the connection API is as shown in Table 1 below.

```
TABLE 1
      x-ssp-multiple-api : on or off
      x-ssp-multiple-api-method : link (serial processing) or parallel
(parallel processing)
      x-ssp-multiple-api-1-name : request API name
      x-ssp-multiple-api-1-param1 : user ID
      x-ssp-multiple-api-1-param2 : device ID
      x-ssp-transactionid : transaction ID
```

In Table 1 above, “x-ssp-multiple-api” is a parameter indicating whether the called API corresponds to the multiple APIs. When “x-ssp-multiple-api” is ON, it refers to the connection API of the multiple APIs. “x-ssp-multiple-api-method” is a parameter indicating a method of processing the multiple APIs. Link refers to the API that performs serial processing and parallel refers to the API that performs parallel processing regardless of any sequence. “x-ssp-multiple-api-1-name” denotes a name of the connection API (request API name, for example, API_B in FIG. 1), “x-ssp-multiple-api-1-param1” denotes a user ID, and “x-ssp-multiple-api-1-param2” denotes a device ID. “x-ssp-transactionid” is an identifier indicating that the API server 120 temporarily stores a result value of the connection API and may be information received from the API server 120.

After generating the header of the connection API as described above, the client 110 inserts the header of the connection API into the start API request message, makes a request for the start API to the API server 120 (API_A request+Header (API_B)), and waits for a response. When the API server 120 receives a request for multiple APIs from the client 110, the API server 120 makes a request for result values of the multiple APIs to the database 130, temporarily stores the result value of the API_B, that is, DATA_B between the result values (DATA-A and DATA-B), generates the result value DATA_A of the API_A and the transaction ID of the API_B as a response message, and transmits the generated response message to the client 110. The transaction ID may be position information of the storage that stores the result value of the API_B corresponding to DATA_B. The client 110 processes the result value DATA_A of API_A from the response message of the API_A received in operation 219 and stores the transaction ID of the API_B corresponding to the connection API. Accordingly, the client 110 adds header information of the connection APIs to the start API and transmits the start API when processing the multiple APIs, and maps transaction IDs of the connection APIs to corresponding APIs when receiving the response message.

When the client 110 detects a call of the connection API, the client 110 detects the call in operation 221, and generates a connection API request message and makes a request for the connection API to the API server 120 in operation 223. At this time, the request message of the API_B corresponding to the connection API is a message (API_B request+Header (B-transaction ID)) including the transaction ID. The API server 120 identifies the transaction ID when receiving the connection API request message, accesses the result value DATA_B of the corresponding connection API (API_B) in the temporary storage 170, and transmits the result value as a response message. In this case, the API server 120 does not perform an operation of making a request for the result value of the connection API to the database 130, and accordingly, can reduce a response time. As such, the client 110 may receive the result value of the connection API in less time in operation 225.

However, when the called API does not correspond to the multiple APIs or the connection API, the client 110 detects that the API is an API having an independent function in operation 221, generates and transmits an API request message in operation 231, and receives and processes a response message transmitted from the API server 120 in operation 233.

Referring to FIG. 3, when the API server 130 receives the API request message from the client 110, the API server 130 detects the reception in operation 311 and parses a header of the API request message to analyze the API in operation 313. At this time, when the API request message includes the header of the connection API (that is, x-ssp-multiple-api is ON), the API server 130 detects that the API corresponds to multiple APIs in operation 313 and analyzes the header of the connection API in operation 315. The API server 120 makes a request for result values of the start API and the connection API to the database 130 in operation 317. Further, the API server 120 temporarily stores the result value (here, DATA_B) of the connection API among the API result values accessed in the database 130 in the temporary storage 170 and generates a transaction ID of the connection API in operation 319. The transaction ID includes position information of the temporary storage that stores the result value of the connection API. The API server 120 transmits the result value of the start API (API_A) and the result value including the transaction ID (DATA_A, API_A response (XMR)+transaction(s) ID (API_B)) to the client 110.

When the API request message received from the client 110 corresponds to the connection API, the API server 120 detects it in operation 331, identifies the transaction ID in the header of the API request message in operation 333, accesses the result value of the connection API in the temporary storage located at a position corresponding to the identified transaction ID, and transmits the result value of the connection API to the client 110 as a response message (DATA_B, API_B response(XML)) in operation 335. Accordingly, the result value of the connection API may be provided immediately when the connection API is requested since the result value of the connection API has been already called when the start API related to the connection API has been processed. Therefore, the API server 120 may multi-process open APIs of independent functions through a one time call when multiple APIs are requested and transmit the pre-processed API result to the client immediately when the API is called. As a result, a response time can be improved.

However, when the API does not correspond to the multiple APIs or the connection API, the API server 120 detects it in operation 331, calls the corresponding API result value from the database 130 in operation 341, and transmits another API result value to the client 110 as a response message in operation 343.

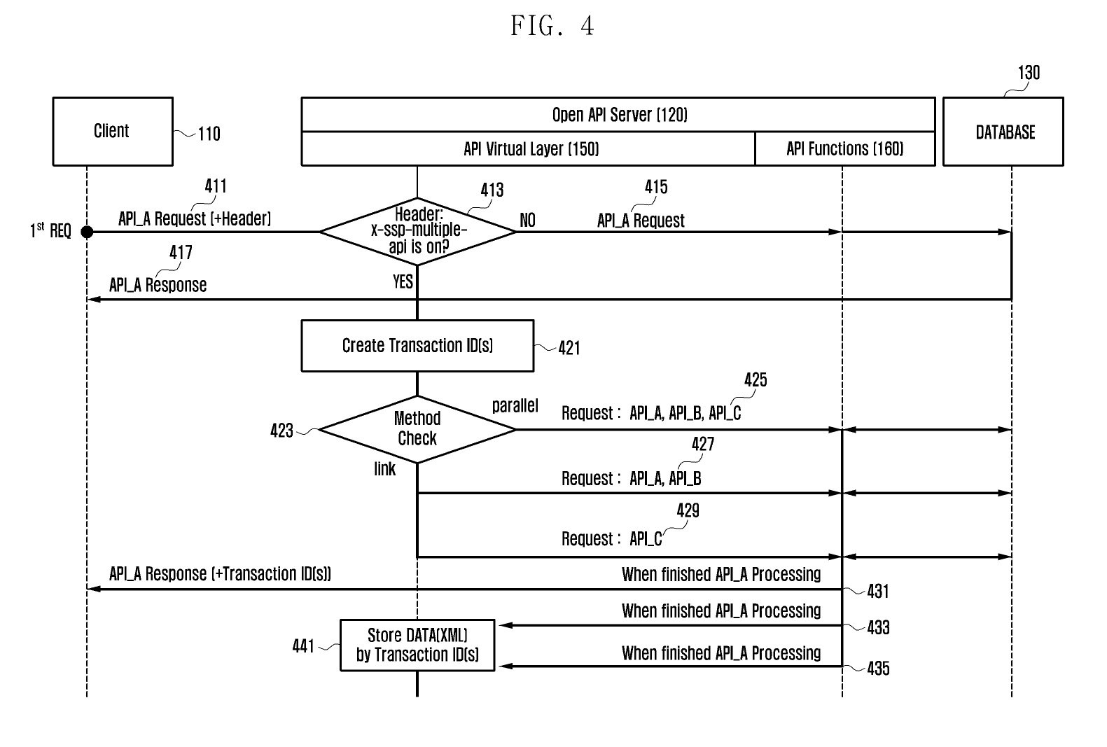

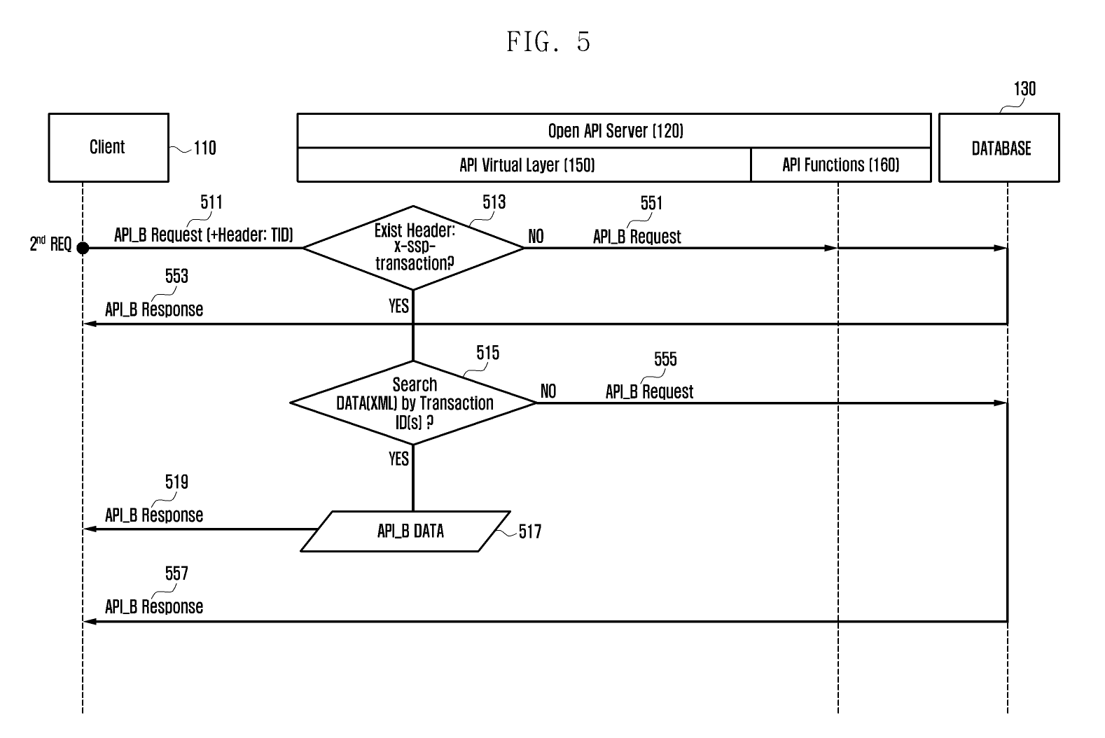

FIGS. 4 and 5 are flowcharts illustrating procedures of processing multiple APIs between the client and the API server according to an embodiment of the present disclosure. FIG. 4 is a flowchart illustrating a procedure of processing a start API of multiple APIs between a client and an API server according to an embodiment of the present disclosure, and FIG. 5 is a flowchart illustrating a procedure of processing a connection API of multiple APIs between a client and an API server according to an embodiment of the present disclosure.

Referring to FIG. 4, the client defines, in a header, connection APIs to be multi-processed by an API (start API) to be first requested when the multiple APIs are requested, and makes a request for transmission of the start API including the header of the connection API in operation 411. When the start API is the API_A, the connection API is the API_B, the multiple API method is the link method, the user ID is w023ndn2ds, and the device ID is 352099011383729, the multiple API request message of the API_A corresponding to the API_A request (+Header) may have a configuration as shown in Table 2 below.

TABLE 2
start API(API_A) request(1st call)

POST http://test.api.com/test/API_A HTTP/1.1
Accept-Encoding:gzip.deflate
Accept: text/xml
User-Agent: Jakarta Commons-HttpClient/3.1
Host test.api.com
x-ssp-multiple-api: on
x-ssp-multiple-api-method: link
x-ssp-multiple-api-1-name: API_B
x-ssp-multiple-api-1-param1: userId/w023ndn2ds
x-ssp-multiple-api-1-param2: deviceId/352099011383729
x-ssp-transationid:
<testAPI_Request>
<useId>testuser</userId>
<dataCode>DATA_A</dataCode>
</testAPI_Request>

The API virtual layer 150 of the API server (Open API Server) 120 analyzes the API request message transmitted from the client 110 to identify whether the API request message corresponds to a multiple API request message in operation 413. That is, the API virtual layer 150 identifies whether x-ssp-multiple-api is in an on state in the header of the request message and determines whether to perform multi-processing. At this time, when x-ssp-multiple-api is in an off state, the API virtual layer 150 detects the off state in operation 413 and makes a request for the API_A to the API functions 160 in operation 415. The API functions 160 access the result value of the API_A in the database 130 and transmit the API_A response message to the client 110. That is, when x-ssp-multiple-api is in the off state, the API server 120 does not perform the multi-processing and transmits the response message of the API_A request (1st API Request) to the client 110.

However, when x-ssp-multiple-api is in the on state, the API virtual layer 150 detects the on state in operation 413 and generates an inherent transaction ID of the corresponding request in operation 421. That is, the API virtual layer 150 generates a transaction ID (here, “API_B_T201303133425500”) of the connection API (API_B) in operation 421.

The API virtual layer 150 checks a multi-processing API method in operation 423. The multiple API method may use a link (serial processing) method and a parallel (parallel processing) method. The link method refers to an API processing method of processing the start API and the connection APIs in a serial order (processing API_A→API_B→API_C), and the parallel method refers to an API processing method of processing the APIs in parallel regardless of orders of the multiple APIs. For example, the multiple APIs in the link method may be multiple APIs having a sequential order of the API processing as registration→search→detailed information request. For example, it is assumed that the multiple APIs include an API_A, an API_B, and an API_C and the API_B and the API_C are connection APIs of the API_A. In this case, when x-ssp-multiple-api-method of the header corresponds to parallel, the API virtual layer 150 simultaneously calls the API_A, the API_B, and the API_C, and the API functions 160 access result values of the APIs from the database 130 regardless of the order of three APIs in operation 425. However, when x-ssp-multiple-api-method of the header corresponds to link, the API virtual layer 150 controls to first call and process the API_A and the API_B in operation 427, and to call and process the API_C in operation 429. When the processing of the API_A is finished, the API virtual layer 150 generates a response message of the API_A and transmits the generated response message to the client 110. The response message of the API_A may be result data (XML) of the API_A and the transaction ID of the connection API generated in operation 421 (API_A response+transaction ID(s)). When the multiple APIs include the API_A and the API_B and the transaction ID of the API_B is API_B_T201303133425500, Table 3 above and the response message of the API_A are transmitted to the client 110. The client 110 receives and processes the response message (DATA_A, XML) of the API_A and also stores the connection API (here, transaction ID of the API_B corresponding to API_B_T201303133425500) in operation 431.

TABLE 3
start API(API_A) response (1st call)

HTTP/1.1 200 OK
Server: nginx/0.7.65
Date: Tue,12 Mar 2013 13:34:27 GMT
Content-Type: text/xml;charset=UTF-8
connection: keep-alive
Content-Language: en-GB
<?xml version=“1.0” encooding=“UTF-8”?>
<response>
<responseCode>200</responseCode>
<responseMsg>DATA_A</responseMsg>
<multipleApiTID>API_B_T201303133425500</multipleApiTID>
</response>

The API virtual layer 150 receives result data of the connection APIs (APIB and API_C) processed by the API functions 160 and stores the result data of the connection APIs in the storage 170 in operations 433 and 435. At this time, the storage 170 may be a memory or a local disk.

Referring to FIG. 5, when the connection API is called in the future, the client 110 transmits the connection API request message to the API server 120 in operation 511. When the connection API is the API_B, the client 110 inserts the transaction ID of the API_B (API_B_T201303133425500) into the request message of the API_B. The API_B request (Header: TID) transmitted to the API server 120 from the client may have a configuration of Table 4 below.

TABLE 4
connection API(API_B) request(2nd call)

POST http://test.api.com/test/API_A HTTP/1.1
Accept-Encoding:gzip.deflate
Accept: text/xml
User-Agent: Jakarta Commons-HttpClient/3.1
Host test.api.com
x-ssp-transactionid: API_B_T201303133425500
<testAPI_Request>
<useId> w023ndn2ds</userId>
<deviceId>352099011383729</deviceId>
</testAPI_Request>

The API virtual layer 150 of the API server 120 inspects the header of the API_B to identify whether there is x-ssp-transactionid in operation 513 (exist header; x-ssp-transactionid?). When there is no x-ssp-transactionid, the API server 120 performs operations 551 and 553 to access result data of the API_B from the database 130 and transmit the result data to the client 110. However, when there is x-ssp-transactionid in the header of the API_B in operation 513, the API virtual layer 150 inspects whether there is result data corresponding to x-ssp-transactionid in the storage 170 (search DATA(XML) by transaction ID(s)?) in operation 515. When there is no result data, the API server 120 performs operations 555 and 557 to access result data of the API B from the database 130 and transmit the result data to the client 110. However, when there is the result data corresponding to the transaction ID in the storage 170 in operation 515, the API virtual layer 150 detects the result data in operation 515, accesses result data (DATA_B, XML) of the API_B from the storage 170 in operation 517, and generates an API_B response message and transmits the API_B response message to the client 110 in operation 519. In this case, the API server 120 generates a pre-processed API response message without calling the database 130, and accordingly, can increase an API response speed. At this time, the API_B response message may have a configuration shown in Table 5 below.

TABLE 5
connection API(API_B) response(2nd call)

HTTP/1.1 200 OK
Server: nginx/0.7.65
Date: Tue,12 Mar 2013 13:34:27 GMT
Content-Type: text/xml;charset=UTF-8
connection: keep-alive
Content-Language: en-GB
<?xml version=“1.0” encooding=“UTF-8”?>
<response>
<responseCode>200</responseCode>
<responseMsg>DATA_B</responseMsg>
</response>

As described above, a processing operation between the client 110 and the API server 120 according to an embodiment of the present disclosure is performed as follows. In processing the multiple APIs, the client 110 defines connection API headers to be multi-processed in the start API request message when the start API is requested (1st request). At this time, as many headers as the number of connection APIs are generated, and the connection API headers may include parameters, such as x-ssp-multiple-api, x-ssp-multiple-api-method, x-ssp-multiple-api-1-name, x-ssp-multiple-api-1-param1, x-ssp-multiple-api-1-param2, and x-ssp-transactionid as shown in Table 1 above.

The API virtual layer 150 of the API server 120 receiving the start API request message of the multiple APIs detects an on state of x-ssp-multiple-api of the received header values of the start API and generates an inherent transaction ID(s) of the corresponding request. Further, the API virtual layer 150 checks x-ssp-multiple-api-method (that is, processing method) from the header value, and makes a request for the processing through the serial processing method to the API functions 160 when the method corresponds to “link” and makes a request for the processing through the parallel processing method to the API functions 160 when the method corresponds to “parallel”. The serial processing (link) method performs the processing in an order of finishing the API_A processing→finishing the API_B processing→ . . . →finishing API_N processing, and the parallel processing (parallel) method performs the simultaneous parallel processing of API_A, API_B, . . . , API_N. When the processing of the start API is finished (first request processing is completed), the API server 120 adds the transaction ID (s) of the connection API to the response result value of the start API and returns the response result value of the start API to the client 110. Further, when the multiple API processing is completed, the API server 120 stores result data (XML) of the connection API in the storage 170.

When the connection APIs processed by the multi-processing request is requested in the start API request (pre-processing API request), the client 110 inserts the transaction ID(s) into the header of the connection API request and transmits the connection API request. The API virtual layer 150 of the API server 120 identifies whether there is x-ssp-transactionid in the header of the connection API request. When there is x-ssp-transactionid, the API virtual layer 150 searches for data with the same ID in the storage 170 and directly returns result data of the connection API to the client 110.

Accordingly, when the multiple APIs are processed, the API server 120 can multi-process the open APIs having independent functions through only a one time call of the client 110. In a case where the open APIs having a relatively long response time are multi-processed, when the client 110 makes a real request for connection APIs, the API server 120 may transmit a result value to the client 110 as a response without querying the database 130.

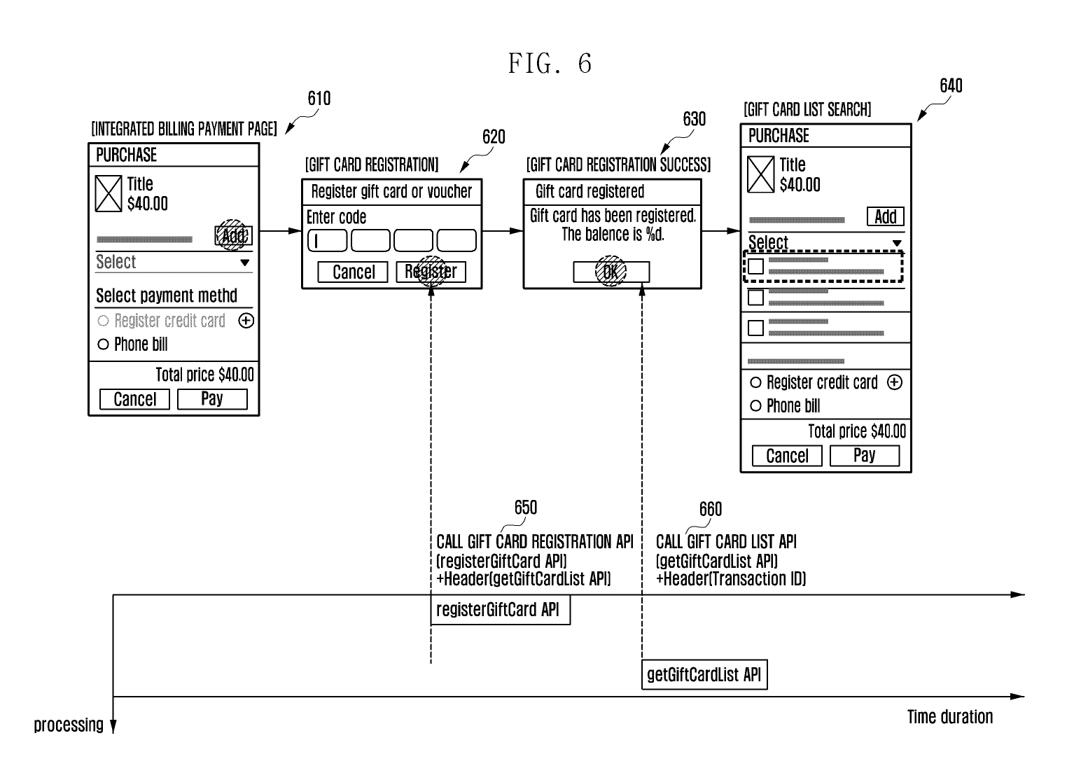

FIG. 6 illustrates an example of processing a gift card registration and list search process through multiple APIs according to an embodiment of the present disclosure.

Referring to FIG. 6, the client 110 may be a portable terminal When a gift card selection button (add button in a screen 610) is selected on an integrated billing payment page screen 610, the client 110 displays a gift card registration screen 620. At this time, when the user selects a registration button (register), the client 110 calls multiple APIs for registering a gift card as indicated by a reference numeral 650. The gift card registration API may be the start API, and the gift card list API may be the connection API. In this case, the client 110 generates header information of the gift card list API when the gift card registration API is requested. The header of the gift card list may be configured as shown in Table 6 below.

TABLE 6

x-ssp-multiple-api : on
x-ssp-multiple-api-method : link
x-ssp-multiple-api-1-name : GiftCardList
x-ssp-multiple-api-1-param1 : user ID
x-ssp-multiple-api-1-param2 : device ID
x-ssp-transationid : transaction ID

The client 110 transmits a multiple API request ((registerGiftCard API)+Header (getGiftCardList API)) to the API server 120 when the gift card registration API is called. The API server generates a transaction ID of getGiftCardList API and calls registerGiftCard API and getGiftCardList API from the database 130. When the processing of registerGiftCard API is completed, the API server generates the transaction ID of getGiftCardList API together with result data (XML) of registerGiftCard API as a response message, transmits the response message, and stores the result data of getGiftCardList API in the storage 170.

At this time, the client 110 receiving the result data (XML) of registerGiftCard API and the transaction ID of getGiftCardList API stores the transaction ID of getGiftCardList API and displays a gift card registration success screen 630. When the user selects an OK button on the screen 630, the client 110 calls getGiftCardList API as indicated by a reference numeral 660. A request message of getGiftCardList API includes the transaction ID ((getGiftCardList API)+Header (Transaction ID)). The API server 120 identifies the transaction ID in the request message of getGiftCardList API, accesses result data of getGiftCardList API from the storage 170, and transmits a response to the client 110. That is, the API server 120 detects that getGiftCardList API corresponds to the connection API, accesses stored and pre-processed result data of getGiftCardList API, and immediately transmits a response to the client 110 without the call of the database. The client 110 displays a gift card list on a screen 640.

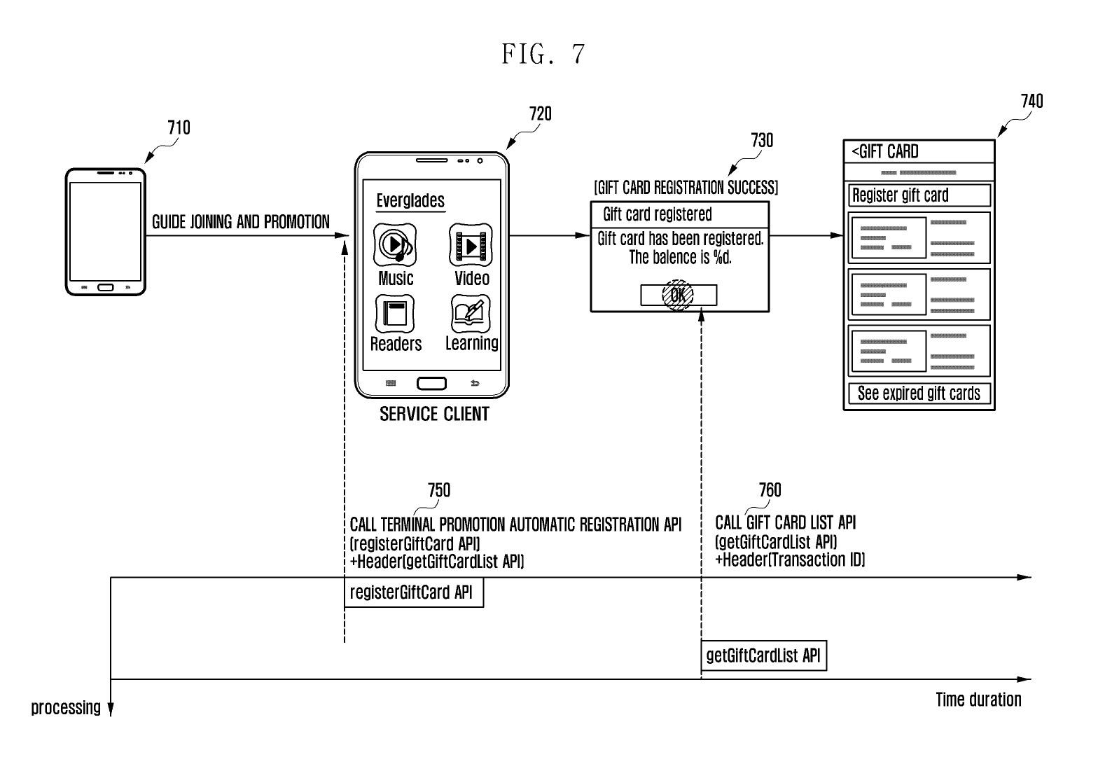

FIG. 7 illustrates a procedure for automatically issuing a gift card of a terminal promotion through multiple APIs according to an embodiment of the present disclosure.

Referring to FIG. 7, the client 110 may be a portable terminal When entering a service on a displayed terminal purchase promotion screen 710, the client displays a screen 720 and automatically calls a terminal promotion automatic registration API as indicated by a reference numeral 750. The terminal promotion automatic registration API (registergiftCardBulk API) may be the start API, and the gift card list API (getGiftCardList API) may be the connection API. In this case, the client 110 generates header information of the gift card list API when the terminal promotion automatic registration API is requested.

The client 110 transmits a multiple API request ((registergiftCardBulk API)+Header(getGiftCardList API)) to the API server 120 when the terminal promotion automatic registration API is called. Then, the API server generates a transaction ID of getGiftCardList API and calls registergiftCardBulk API and getGiftCardList API from the database 130. When the processing of registergiftCardBulk API is completed, the API server generates the transaction ID of getGiftCardList API together with result data (XML) of registergiftCardBulk API as a response message, transmits the response message, and stores the result data of getGiftCardList API in the storage 170.

At this time, the client 110 receiving the result data (XML) of registergiftCardBulk API and the transaction ID of getGiftCardList API stores the transaction ID of getGiftCardList API and displays a gift card registration success screen 730. When the user selects an OK button on the screen 730, the client 110 calls getGiftCardList API as indicated by a reference numeral 760. A request message of getGiftCardList API includes the transaction ID ((getGiftCardList API)+Header (Transaction ID)). The API server 120 identifies the transaction ID in the request message of getGiftCardList API, accesses result data of getGiftCardList API from the storage 170, and transmits a response to the client 110. That is, the API server 120 detects that getGiftCardList API corresponds to the connection API, accesses stored and pre-processed result data of getGiftCardList API, and immediately transmits a response to the client 110 without the call of the database. The client 110 displays a gift card list on a screen 740.

While the present disclosure has been shown and described with reference to various embodiments thereof, it will be obvious by those skilled in the art that various changes in form and details may be made therein without departing from the spirit and scope of the present disclosure as defined by the appended claims and their equivalents.

What is claimed is:

1. A method of processing multiple Application Programming Interfaces (API) by an API server, the method comprising:
receiving a request message of a first API from a terminal, the request message including information, on one or more second APIs associated with the first API;
identifying the one or more second APIs by analyzing the information;
searching for result data or the first API and the one or more second APIs in a database;
storing the result data of the one or more second APIs; and
transmitting a response message including the result data of the first API to the terminal.

2. The method of claim 1, further comprising:
receiving a request message of the one or more second APIs from the terminal; and
transmitting a response message including the stored result data of the second APIs to the terminal.

3. The method of claim 2, wherein the API corresponds to an open API.

4. The method of claim 3, wherein the information on the second APIs corresponds to a header of the first API, and the header includes a parameter indicating whether multi-processing is performed and a parameter indicating a multi-processing method.

5. The method of claim 4, wherein the transmitting of the response message comprises transmitting a response message including the result data of the first API including transaction IDs of the second APIs.

6. The method of claim 4, wherein the searching for the result data comprises, when the parameter indicating the multi-processing method corresponds to a link method, sequentially searching for the result data of the first API and the one or more second APIs to be multi-processed in the data base and storing the result data.

7. The method of claim 4, wherein the searching for the result data comprises, when the parameter indicating the multi-processing method corresponds to a parallel method, searching in parallel for the result data of the first API and the one or more second APIs to be multi-processed in the database and storing the result data.

8. The method of claim 4, wherein the result data of the APIs comprises XML data.

9. The method of claim 5, wherein the transmitting of the response message of the second APIs comprises analyzing the transaction ID and transmitting the corresponding stored result data of the second APIs as the response data when receiving the request message of the second APIs.

10. A method of processing multiple Application Programming Interfaces (APIs) by a terminal apparatus, the method comprising:
transmitting a request message of a first API to an API server, the request message including information on one or more second APIs associated with the first API; and
receiving a response message including result data of the first API from the API server,
wherein the API server processes and stores result data of the second APIs after transmitting the response message of the first API.

11. The method of claim 10, further comprising:
transmitting a request message of the second APIs to the API server; and
receiving a response message including the stored result data of the second APIs.

12. The method of claim 11, wherein the API corresponds to an open API.

14. The method of claim 12, wherein the information on the second APIs included in the request message includes a parameter indicating whether multi-processing is performed, a parameter indicating a multi-processing method, a name of a connection parameter, a user of a connection parameter, and a device name.

15. The method of claim 14, wherein transmission of the request message of the second APIs is performed after a response of the first API is processed.

16. The method of claim 15, wherein the response message including the result data of the first API includes transaction IDs of the second APIs, and the transmitting of the request message of the second APIs comprises inserting the transaction IDs of the second APIs into the request message of the second APIs and transmitting the request message of the second APIs to the API server.)

17. An Application Programming Interface (API) server apparatus for processing multiple APIs, the API server apparatus comprising:
an API virtual layer configured to receive a request message of a first API including information on one or more second APIs associated with the first API transmitted from a terminal, to analyze the information to identify the one or more second APIs, to search for and process result data of the first API and the one or more second APIs in a database, and to transmit a response message including the result data of the first API to the terminal;
API functions configured to search for result data of a start API and a connection API in the database and to generate the result data under a control of the API virtual layer; and
a storage configured to store the result data of the connection API under a control of the API virtual layer.

18. The API server apparatus of claim 17, wherein, when the API virtual layer receives a request message of the one or more second APIs from the terminal, the API virtual layer is further configured to transmit a response message including the result data of the second APIs stored in the storage to the terminal.

19. The API server apparatus of claim 18, wherein the information on the second APIs corresponds to a header of the first API, and the header includes a parameter indicating whether multi-processing is performed and a parameter indicating a multi-processing method.

20. The API server apparatus of claim 17, wherein, when the parameter indicating the multi-processing method corresponds to a link method, the API virtual layer is further configured to control to sequentially search for the result data of the start API and one or more connection APIs in the database.

21. The API server apparatus of claim 17, wherein, when the parameter indicating the multi-processing method corresponds to a parallel method, the API virtual layer is further configured to control to search in parallel for the result data of the start API and one or more connection APIs in the database regardless of an order.

22. The API server apparatus of claim 17, wherein the API vinital layer is further configured to transmit a response message of the first API including transaction IDs of the second APIs to the terminal and store processed result data of the second APIs in the storage to correspond to the transaction IDs of the second APIs.

23. A terminal apparatus for processing multiple Application Programmer Interfaces (APIs), the terminal apparatus comprising:
a communciation unit configured to transmit a request message of a first API including information on one or more second APIs connected to the first API to an API server and to receive a response message transmitted from the API server;
a storage unit configured to store a response message of the first API; and
a controller configured to generate the request message of the first API, to output the request message to the communication unit, and, when the communication unit receives a response message including result data of the first API, to store identification information of the second APIs included in the response message in the storage unit.

24. The terminal apparatus of claim 23, wherein the response message of the first API includes identification information corresponding to the connected second APIs, and the controller is further configured to generate a request message of the second APIs including the identification information of the corresponding second APIs in the storage unit, and to output the generated request message to the communication unit when the second APIs are requested, and to receive result data of the second APIs from the communication unit and processes the received result data.

25. The terminal apparatus of claim 24, wherein the information on the second APIs included in the request message of the first API includes a parameter indicating whether multi-processing is performed, a parameter indicating a multi-processing method; a name of a connection parameter, a user of a connection parameter, and a device name.

26. The terminal apparatus of claim 25, wherein the identification information of the second APIs corresponds to transaction IDs of the second APIs assigned by the API.
